(19) United States
(12) Patent Application Publication
(10) Pub. No.: US 2009/0278342 A1
(43) Pub. Date: Nov. 12, 2009

(54) Vehicle roll bar apparatus with active material actuation

(75) Inventors: Alan L. Browne, Grosse Pointe, MI (US); Nancy L. Johnson, Northville, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/115,896

(22) Filed: May 6, 2008

(51) Int. Cl. B60R 21/13

(52) U.S. Cl. 280/756

(57) ABSTRACT

A vehicle includes a vehicle body, a roll bar, and an actuator configured to selectively move the roll bar with respect to the vehicle body between a stowed position and a deployed position. The actuator includes an active material that is configured to change in size, shape, or modulus in response to an activation signal, thereby causing movement of the roll bar.

### TECHNICAL FIELD

This invention relates to vehicle roll bars having actuators for movement between stowed and deployed positions and/or deployed and stowed positions.

### BACKGROUND OF THE INVENTION

Some prior art vehicles include a roll bar that is positioned above a passenger compartment. In vehicles such as convertibles, the roll bar alters the appearance and style of the vehicle when the convertible top is stowed.

### SUMMARY OF THE INVENTION

A vehicle includes a vehicle body, a roll bar mounted with respect to the vehicle body, and an actuator. The roll bar is selectively movable with respect to the vehicle body between a stowed position and a deployed position. The actuator includes an active material that is configured to change at least one attribute in response to an activation signal. The active material is operatively connected to the roll bar such that the change in at least one attribute of the active material causes the roll bar to move relative to the vehicle body.

Accordingly, the roll bar may be stowed during normal driving conditions, and deployed when desired. The active material-based actuator provides rapid and in certain embodiments reversible deployment of the roll bar.

A roll bar apparatus for a vehicle is also provided. The apparatus includes a roll bar and an actuator. The actuator has an active material that is configured to undergo a change in at least one attribute in response to an activation signal. The active material is operatively connected to the roll bar such that the change in at least one attribute causes movement of the roll bar.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1A is a schematic side view of a vehicle including a roll bar in a stowed position and an actuator configured to selectively move the roll bar;

FIG. 1B is a schematic, sectional view of the vehicle of FIG. 1A with the roll bar in the stowed position;

FIG. 2A is a schematic, sectional view of the vehicle of FIG. 1A with the roll bar in a deployed position;

FIG. 2B is a schematic front view of the vehicle of FIG. 1A with the roll bar in the deployed position;

FIG. 3A is a schematic side view of a selectively rotatable roll bar in a stowed position with a cam actuator;

FIG. 3B is a schematic side view of the roll bar of FIG. 3A in a deployed position;

FIG. 3C is a schematic front view of the roll bar of FIGS. 3A and 3B;

FIG. 4A is a schematic front view of a roll bar having a segmented cross member in a stowed position;

FIG. 4B is a schematic front view of the roll bar of FIG. 4A in a deployed position;

FIG. 5A is a schematic front view of a roll bar having a flexible cross member in a stowed position;

FIG. 5B is a schematic front view of the roll bar of FIG. 5A in a deployed position; and

FIG. 6 is a schematic depiction of a roll bar deployment system.

### DESCRIPTION OF THE PREFERRED EMBODIMENTS

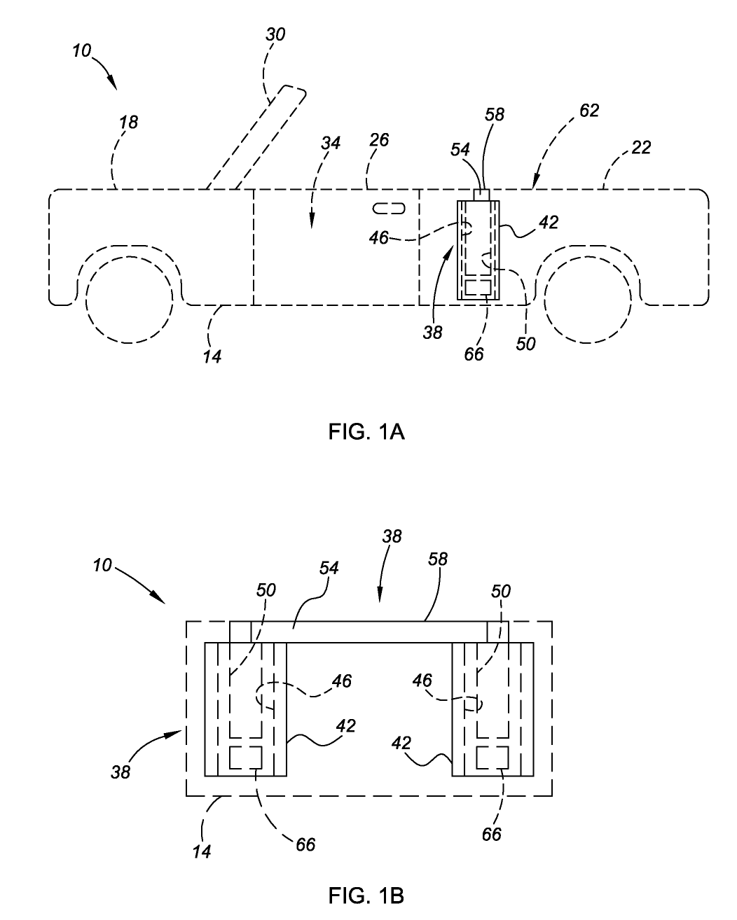

Referring to FIG. 1A, a vehicle 10 includes a vehicle body 14. The body 14 includes body panels such as fenders 18, rear quarter panels 22, and doors 26. The body 14 also includes A-pillars 30 for supporting a windshield (not shown). The body 14 defines a passenger compartment 34, as understood by those skilled in the art. The body 14 in the embodiment depicted is a convertible, i.e., a top (not shown) is selectively removable or stowable such that the passenger compartment 34 is uncovered, as shown in FIG. 1A. It should be noted that the vehicle body 14 may have a configuration other than a convertible configuration within the scope of the claimed invention. For example, the body 14 may be a sedan, coupe, pickup truck, sport-utility vehicle, minivan, hatchback, etc.

The vehicle 10 also includes a selectively deployable roll bar system 38. In the embodiment depicted, the roll bar system 38 is located behind the passenger compartment 34. Referring to FIGS. 1A and 1B, the roll bar system 38 includes two cylindrical members 42, each being mounted to the body 14 and each defining a respective cylindrical cavity 46 that is upwardly open. Members 42 and cavities 46 are cylindrical in the embodiment depicted, but may be characterized by any shape within the scope of the claimed invention. The roll bar system 38 also includes two posts 50 rigidly interconnected by a cross member 54. The posts 50 and cross member 54 cooperate to define a selectively movable roll bar 58. The roll bar 58 is depicted in a lowered, stowed position in FIGS. 1A and 1B. When the roll bar 58 is in the stowed position, each post 50 is substantially entirely located within a respective one of the cavities 46, and the roll bar 58 is below the upper surface 62 of the body 14. It should be noted that, within the scope of the claimed invention, a roll bar may be above the upper surface in the stowed position.

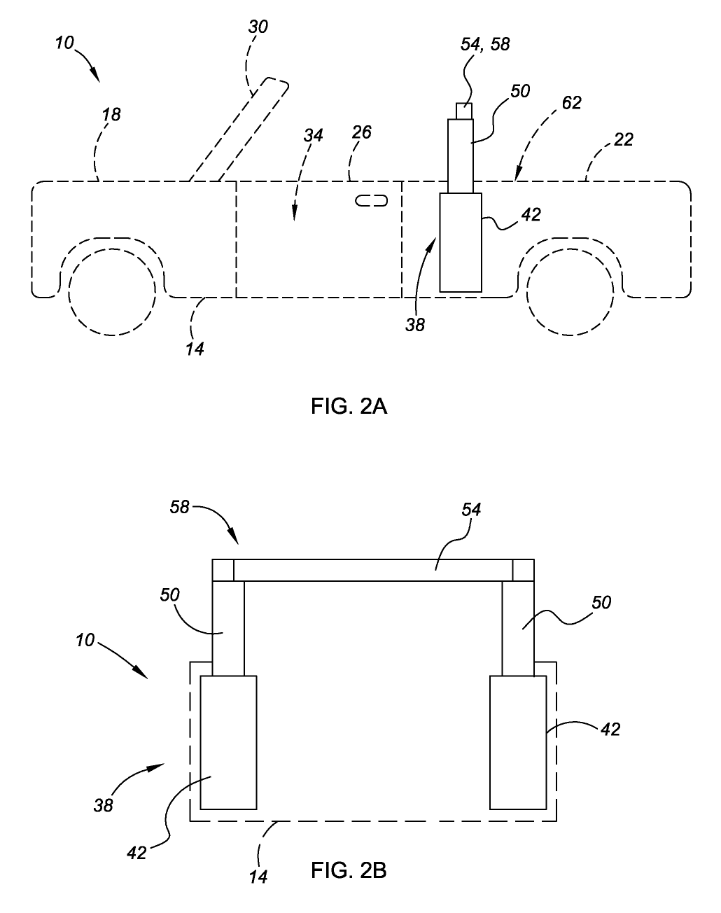

The roll bar 58 is selectively movable with respect to the body 14 and cylinders 42 from the stowed position to an elevated, deployed position, as shown in FIGS. 2A and 2B. Referring to FIGS. 2A and 2B, wherein like reference numbers refer to like components from FIGS. 1A and 1B, when the roll bar 58 is in the deployed position, at least part of the posts 50 are raised outside of the cavities 46 to support the cross member 54 above the exterior surface 62 of the body 14. The roll bar system 38 includes at least one active materials based actuator 66 that is configured to selectively move the roll bar 58 between its stowed position and its deployed position. In the embodiment depicted, the roll bar system 38 includes two actuators 66 configured to selectively raise and lower a respective post 50. The surfaces defining the cavities 46 guide the posts 50 so that the posts 50, and therefore the roll bar 58, are limited to generally vertical translation. An exemplary location for the actuators 66 is inside the cavities 46 of members 42.

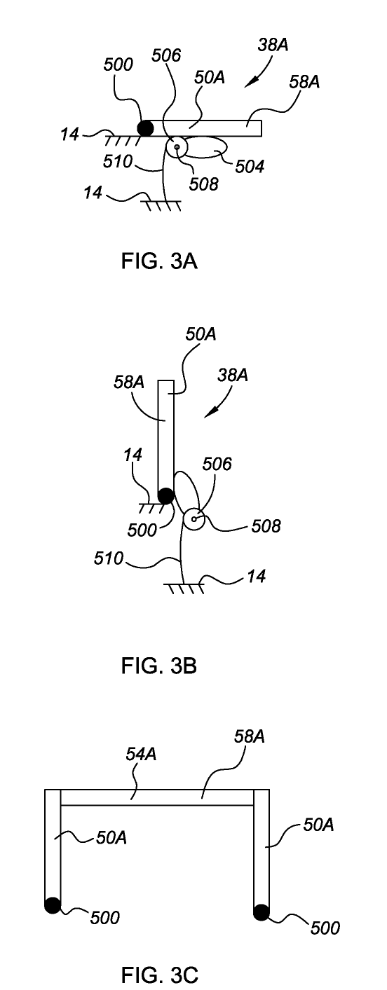

Referring to FIGS. 3A-3C, wherein like reference numbers refer to like components from FIGS. 1A-2B, roll bar system 38A is configured such that roll bar 58A is rotatable about hinges 500 between a stowed position with respect to the vehicle body 14, as shown in FIG. 3A, and a deployed position with respect to the vehicle body 14, as shown in FIG. 3B. Roll bar system 38A includes two posts 50A that are rigidly interconnected by cross member 54A. Cross member 54A and posts 50A cooperate to define roll bar 58A.

Each post 50A is rotatably mounted to the body 14 at a respective hinge 500. The roll bar system 38A has an active material based actuator that includes a cam 504. The cam 504 is rotatably mounted with respect to the vehicle body 14 via a hinge 508. The cam 504 is rotatable about the hinge 508 between a first position, as shown in FIG. 3A, and a second position, as shown in FIG. 3B. The cam 504 is in contact with one of the posts 50A such that rotation of the cam 504 about hinge 508 causes rotation of the post 50A about hinge 500.

Referring specifically to FIG. 3A, the roll bar 58A is in the stowed position, and the cam 504 is in the first position. During rotation of the cam 504 from the first position to the second position, the lobe of the cam 504 acts on the post 50A, causing the post 50A, and, therefore, the roll bar 58A, to rotate about hinge 500 to the deployed position, as shown in FIG. 3B.

A pulley 506 is mounted with respect to the cam 504 for rotation therewith about hinge 508. A member formed of active material is operatively connected to the cam 504 and configured to cause the cam 504 to rotate in response to an activation signal. In the embodiment depicted, the member formed of active material is a wire 510 comprising shape memory alloy. One end of the wire 510 is mounted to the vehicle body 14. The other end of the wire is wound about the pulley 506.

The wire 510 is characterized by pseudoplastic tensile strain when the cam 504 is in the first position. Applying a thermal activation signal so that the wire 510 is heated to its hot state causes the pseudoplastic tensile strain to be reversed, thereby reducing the length of the wire 510 and causing rotation of the pulley 506 and, correspondingly, the cam 504. The pseudoplastic tensile strain is sufficient such that the contraction of the wire 510 in response to the activation signal is sufficient to rotate the cam 504 from the first position to the second position.

It may be desirable to employ a latch (not shown) to lock the roll bar 58 in its deployed position; in the absence of a latch, it may be necessary to maintain the activation signal to the active material member to maintain the roll bar 58A in the deployed position.

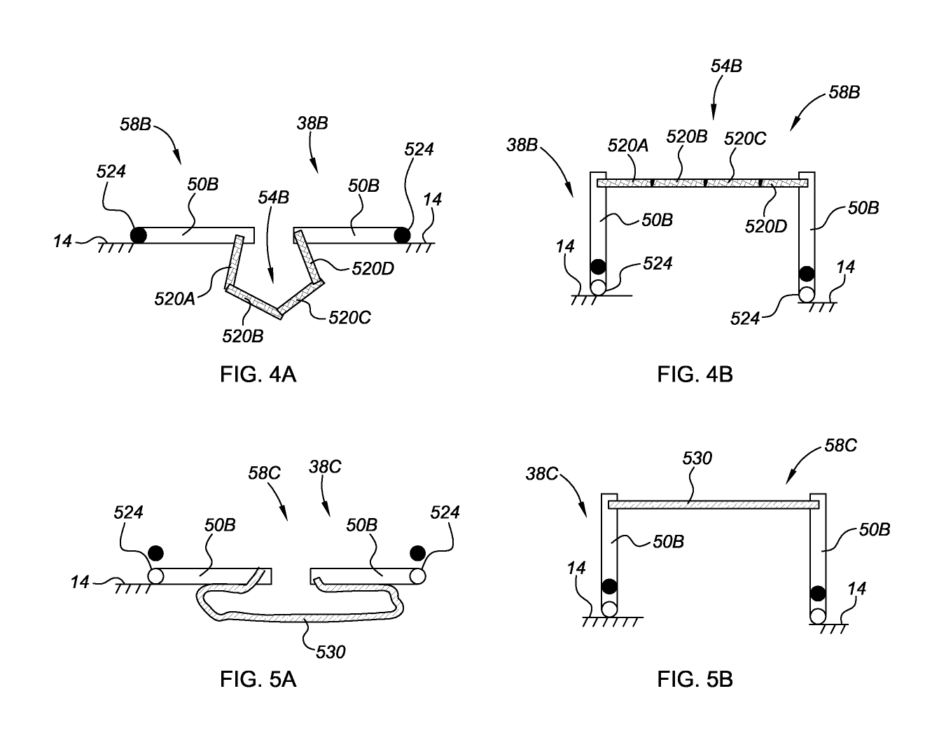

Referring to FIGS. 4A and 4B, wherein like reference numbers refer to like components from FIGS. 1A-3C, roll bar system 38B includes two posts 50B. Each of the posts 50B are rotatably mounted to the vehicle body 14 by a respective hinge 524. The cross member 54B includes four rigid segments 520A-D. Segment 520A is pivotably connected to one of the posts 50B and to segment 520B. Segment 520B is pivotably connected to segment 520A and to segment 520C. Segment 520C is pivotably connected to segment 520B and to segment 520D. Segment 520D is pivotably connected to segment 520C and to the other post 50B.

The cross member 54B is collapsible when the roll bar 58B is in its stowed position, as shown in FIG. 4A. In the stowed position, the posts 50B are oriented substantially horizontally and are transversely oriented with respect to the vehicle body 14. When the posts 50B rotate about their respective hinges 524 such that the posts 50B are generally vertically oriented, as shown in FIG. 4B, the segments 520A-D align such that the cross member 54B is linear. At least one active material based actuator (shown at 66 in FIG. 1) is operatively connected to the posts 50B to selectively rotate the posts 50B between their horizontal and vertical positions.

Referring to FIGS. 5A and 5B, wherein like reference numbers refer to like components from FIGS. 1A-4B, roll bar system 38C includes two posts 50B. Each of the posts 50B is rotatably mounted to the vehicle body 14 by a respective hinge 524. The cross member is a flexible member 530 such as a cable or wire. The posts 50B and the flexible member 530 cooperate to define a roll bar 58C. The flexible member 530 is collapsible when the roll bar 58C is in its stowed position, as shown in FIG. 5A. In the stowed position, the posts 50B are oriented substantially horizontally and are transversely oriented with respect to the vehicle body 14. When the posts 50B rotate about their respective hinges 524 such that the posts 50B are generally vertically oriented, as shown in FIG. 5B, the posts 50B cause tension in the flexible member 530, thereby causing the flexible member 530 to be substantially linear and horizontally oriented. At least one active material based actuator (shown at 66 in FIG. 1) is operatively connected to the posts 50B to selectively rotate the posts 50B between their horizontal and vertical positions.

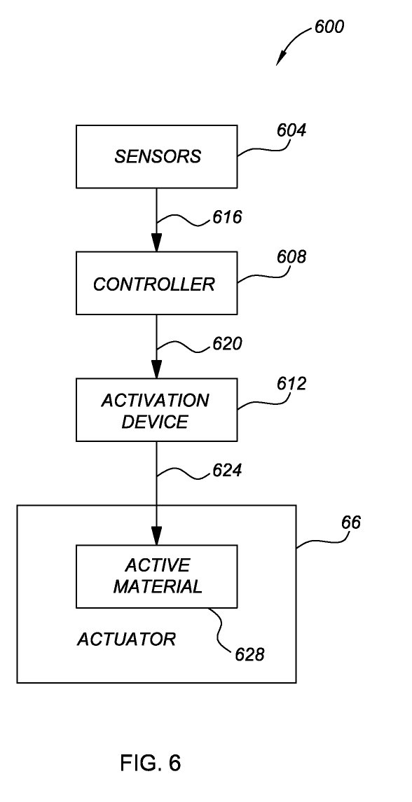

Referring to FIG. 6, wherein like reference numbers refer to like components from FIGS. 1A-5B, a control system 600 is schematically depicted. The control system 600 includes a plurality of sensors 604, a controller 608, and an activation device 612. The sensors 604 monitor various vehicle conditions and transmit sensor signals 616 indicative of the vehicle conditions to the controller 608. The controller 608 is configured to transmit a command signal 620 to the activation device 612 if the controller 608 determines that the sensor signals 616 indicate that one or more predetermined conditions exist. The activation device 612 is configured to respond to the command signal 620 by transmitting an activation signal 624 to the active material 628 of actuator 66.

The active material 628 is configured to undergo a change in at least one attribute in response to the activation signal 624. The active material 628 is operatively connected to the roll bar (shown at 58 in FIG. 1A) such that the change in at least one attribute causes the roll bar to move from the stowed position to the deployed position, and/or from the deployed position to the stowed position. Thus, the activation signal 624 causes movement of the roll bar. Exemplary material attributes that change in response to the activation signal 624 include, but are not limited to, dimensions, shape, stiffness (elastic or flexural modulus), etc. The activation signal provided by the activation device 612 may include a heat signal, a magnetic signal, an electrical signal, a pneumatic signal, a mechanical signal, and the like, and combinations comprising at least one of the foregoing signals, with the particular activation signal dependent on the materials and/or configuration of the active material.

For example, a magnetic and/or an electrical signal may be applied for changing the property of an active material fabricated from magnetostrictive materials. A heat signal may be applied for changing the property of an active material fabricated from shape memory alloys and/or shape memory polymers. An electrical signal may be applied for changing the property of an active material fabricated from electroactive materials, piezoelectrics, electrostatics, and/or ionic polymer metal composite materials.

Suitable active materials include, without limitation, shape memory alloys (SMA), shape memory polymers (SMP), piezoelectric materials, electroactive polymers (EAP), ferromagnetic materials, magnetorheological fluids and elastomers (MR) and electrorheological fluids (ER). SMA and EAP are suitable as actuators for direct deploy and or stowing. Piezo materials, shape memory polymers, ER and MR fluids, and MR elastomers are principally suitable as smart material based releasable on demand latch mechanisms because of either their small displacement as in the case of piezos or controllable modulus as exists with the other materials.

Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Other suitable active materials are shape memory polymers. Similar to the behavior of a shape memory alloy, when the temperature is raised through its transition temperature, the shape memory polymer also undergoes a change in shape orientation. Dissimilar to SMAs, raising the temperature through the transition temperature causes a substantial drop in modulus. While SMAs are well suited as actuators, SMPs are better suited as “reverse” actuators. That is, by undergoing a large drop in modulus by heating the SMP past the transition temperature, release of stored energy blocked by the SMP in its low temperature high modulus form can occur. To set the permanent shape of the shape memory polymer, the polymer must be at about or above the Tg or melting point of the hard segment of the polymer. “Segment” refers to a block or sequence of polymer forming part of the shape memory polymer. The shape memory polymers are shaped at the temperature with an applied force followed by cooling to set the permanent shape. The temperature necessary to set the permanent shape is preferably between about 100° C. to about 300° C. Setting the temporary shape of the shape memory polymer requires the shape memory polymer material to be brought to a temperature at or above the Tg or transition temperature of the soft segment, but below the Tg or melting point of the hard segment. At the soft segment transition temperature (also termed “first transition temperature”), the temporary shape of the shape memory polymer is set followed by cooling of the shape memory polymer to lock in the temporary shape. The temporary shape is maintained as long as it remains below the soft segment transition temperature. The permanent shape is regained when the shape memory polymer fibers are once again brought to or above the transition temperature of the soft segment. Repeating the heating, shaping, and cooling steps can reset the temporary shape. The soft segment transition temperature can be chosen for a particular application by modifying the structure and composition of the polymer. Transition temperatures of the soft segment range from about −63° C. to above about 120° C.

Shape memory polymers may contain more than two transition temperatures. A shape memory polymer composition comprising a hard segment and two soft segments can have three transition temperatures: the highest transition temperature for the hard segment and a transition temperature for each soft segment.

Most shape memory polymers exhibit a “one-way” effect, wherein the shape memory polymer exhibits one permanent shape. Upon heating the shape memory polymer above the first transition temperature, the permanent shape is achieved and the shape will not revert back to the temporary shape without the use of outside forces. As an alternative, some shape memory polymer compositions can be prepared to exhibit a “two-way” effect. These systems consist of at least two polymer components. For example, one component could be a first cross-linked polymer while the other component is a different cross-linked polymer. The components are combined by layer techniques, or are interpenetrating networks, wherein two components are cross-linked but not to each other. By changing the temperature, the shape memory polymer changes its shape in the direction of the first permanent shape of the second permanent shape. Each of the permanent shapes belongs to one component of the shape memory polymer. The two permanent shapes are always in equilibrium between both shapes. The temperature dependence of the shape is caused by the fact that the mechanical properties of one component (“component A”) are almost independent from the temperature in the temperature interval of interest. The mechanical properties of the other component (“component B”) depend on the temperature. In one embodiment, component B becomes stronger at low temperatures compared to component A, while component A is stronger at high temperatures and determines the actual shape. A two-way memory device can be prepared by setting the permanent shape of component A (“first permanent shape”); deforming the device into the permanent shape of component B (“second permanent shape”) and fixing the permanent shape of component B while applying a stress to the component.

Similar to the shape memory alloy materials, the shape memory polymers can be configured in many different forms and shapes. The temperature needed for permanent shape recovery can be set at any temperature between about −63° C. and about 120° C. or above. Engineering the composition and structure of the polymer itself can allow for the choice of a particular temperature for a desired application. A preferred temperature for shape recovery is greater than or equal to about −30° C., more preferably greater than or equal to about 0° C., and most preferably a temperature greater than or equal to about 50° C. Also, a preferred temperature for shape recovery is less than or equal to about 120° C., more preferably less than or equal to about 90° C., and most preferably less than or equal to about 70° C.

Suitable shape memory polymers include thermoplastics, thermosets, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether) ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsesquioxane), polyvinylchloride, urethane/butadiene copolymers, polyurethane block copolymers, styrene-butadiene-styrene block copolymers, and the like.

The shape memory polymer or the shape memory alloy, may be activated by any suitable means, preferably a means for subjecting the material to a temperature change above, or below, a transition temperature. For example, for elevated temperatures, heat may be supplied using hot gas (e.g., air), steam, hot liquid, or electrical current. The activation means may, for example, be in the form of heat conduction from a heated element in contact with the shape memory material, heat convection from a heated conduit in proximity to the thermally active shape memory material, a hot air blower or jet, microwave interaction, resistive heating, and the like. In the case of a temperature drop, heat may be extracted by using cold gas, or evaporation of a refrigerant. The activation means may, for example, be in the form of a cool room or enclosure, a cooling probe having a cooled tip, a control signal to a thermoelectric unit, a cold air blower or jet, or means for introducing a refrigerant (such as liquid nitrogen) to at least the vicinity of the shape memory material.

Suitable magnetic materials include, but are not intended to be limited to, soft or hard magnets; hematite; magnetite; magnetic material based on iron, nickel, and cobalt, alloys of the foregoing, or combinations comprising at least one of the foregoing, and the like. Alloys of iron, nickel and/or cobalt, can comprise aluminum, silicon, cobalt, nickel, vanadium, molybdenum, chromium, tungsten, manganese and/or copper.

Suitable MR fluid materials include, but are not intended to be limited to, ferromagnetic or paramagnetic particles dispersed in a carrier fluid. Suitable particles include iron; iron alloys, such as those including aluminum, silicon, cobalt, nickel, vanadium, molybdenum, chromium, tungsten, manganese and/or copper; iron oxides, including Fe2O3 and Fe3O4; iron nitride; iron carbide; carbonyl iron; nickel and alloys of nickel; cobalt and alloys of cobalt; chromium dioxide; stainless steel; silicon steel; and the like. Examples of suitable particles include straight iron powders, reduced iron powders, iron oxide powder/straight iron powder mixtures and iron oxide powder/reduced iron powder mixtures. A preferred magnetic-responsive particulate is carbonyl iron, preferably, reduced carbonyl iron.

The particle size should be selected so that the particles exhibit multi-domain characteristics when subjected to a magnetic field. Average dimension sizes for the particles can be less than or equal to about 1,000 micrometers, with less than or equal to about 500 micrometers preferred, and less than or equal to about 100 micrometers more preferred. Also preferred is a particle dimension of greater than or equal to about 0.1 micrometer, with greater than or equal to about 0.5 more preferred, and greater than or equal to about 10 micrometers especially preferred. The particles are preferably present in an amount between about 5.0 to about 50 percent by volume of the total MR fluid composition.

Suitable carrier fluids include organic liquids, especially non-polar organic liquids. Examples include, but are not limited to, silicone oils; mineral oils; paraffin oils; silicone copolymers; white oils; hydraulic oils; transformer oils; halogenated organic liquids, such as chlorinated hydrocarbons, halogenated paraffins, perfluorinated polyethers and fluorinated hydrocarbons; diesters; polyoxyalkylenes; fluorinated silicones; cyanoalkyl siloxanes; glycols; synthetic hydrocarbon oils, including both unsaturated and saturated; and combinations comprising at least one of the foregoing fluids.

The viscosity of the carrier component can be less than or equal to about 100,000 centipoise, with less than or equal to about 10,000 centipoise preferred, and less than or equal to about 1,000 centipoise more preferred. Also preferred is a viscosity of greater than or equal to about 1 centipoise, with greater than or equal to about 250 centipoise preferred, and greater than or equal to about 500 centipoise especially preferred.

Aqueous carrier fluids may also be used, especially those comprising hydrophilic mineral clays such as bentonite or hectorite. The aqueous carrier fluid may comprise water or water comprising a small amount of polar, water-miscible organic solvents such as methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like. The amount of polar organic solvents is less than or equal to about 5.0% by volume of the total MR fluid, and preferably less than or equal to about 3.0%. Also, the amount of polar organic solvents is preferably greater than or equal to about 0.1%, and more preferably greater than or equal to about 1.0% by volume of the total MR fluid. The pH of the aqueous carrier fluid is preferably less than or equal to about 13, and preferably less than or equal to about 9.0. Also, the pH of the aqueous carrier fluid is greater than or equal to about 5.0, and preferably greater than or equal to about 8.0.

Natural or synthetic bentonite or hectorite may be used. The amount of bentonite or hectorite in the MR fluid is less than or equal to about 10 percent by weight of the total MR fluid, preferably less than or equal to about 8.0 percent by weight, and more preferably less than or equal to about 6.0 percent by weight. Preferably, the bentonite or hectorite is present in greater than or equal to about 0.1 percent by weight, more preferably greater than or equal to about 1.0 percent by weight, and especially preferred greater than or equal to about 2.0 percent by weight of the total MR fluid.

Optional components in the MR fluid include clays, organoclays, carboxylate soaps, dispersants, corrosion inhibitors, lubricants, extreme pressure anti-wear additives, antioxidants, thixotropic agents and conventional suspension agents. Carboxylate soaps include ferrous oleate, ferrous naphthenate, ferrous stearate, aluminum di- and tri-stearate, lithium stearate, calcium stearate, zinc stearate and sodium stearate, and surfactants such as sulfonates, phosphate esters, stearic acid, glycerol monooleate, sorbitan sesquioleate, laurates, fatty acids, fatty alcohols, fluoroaliphatic polymeric esters, and titanate, aluminate and zirconate coupling agents and the like. Polyalkylene diols, such as polyethylene glycol, and partially esterified polyols can also be included.

Suitable MR elastomer materials include, but are not intended to be limited to, an elastic polymer matrix comprising a suspension of ferromagnetic or paramagnetic particles, wherein the particles are described above. Suitable polymer matrices include, but are not limited to, poly-alpha-olefins, natural rubber, silicone, polybutadiene, polyethylene, polyisoprene, and the like.

Electroactive polymers include those polymeric materials that exhibit piezoelectric, pyroelectric, or electrostrictive properties in response to electrical or mechanical fields. The materials generally employ the use of compliant electrodes that enable polymer films to expand or contract in the in-plane directions in response to applied electric fields or mechanical stresses. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator. Activation of an EAP based pad preferably utilizes an electrical signal to provide change in shape orientation sufficient to provide displacement. Reversing the polarity of the applied voltage to the EAP can provide a reversible lockdown mechanism.

Materials suitable for use as the electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that is has an elastic modulus at most about 100 MPa. In another embodiment, the polymer is selected such that is has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thicknesses suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

The active material may also comprise a piezoelectric material. Also, in certain embodiments, the piezoelectric material may be configured as an actuator for providing rapid deployment. As used herein, the term “piezoelectric” is used to describe a material that mechanically deforms (changes shape) when a voltage potential is applied, or conversely, generates an electrical charge when mechanically deformed. Employing the piezoelectric material will utilize an electrical signal for activation. Upon activation, the piezoelectric material can cause displacement in the powered state. Upon discontinuation of the activation signal, the strips will assume its original shape orientation, e.g., a straightened shape orientation.

Preferably, a piezoelectric material is disposed on strips of a flexible metal or ceramic sheet. The strips can be unimorph or bimorph. Preferably, the strips are bimorph, because bimorphs generally exhibit more displacement than unimorphs.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Suitable piezoelectric materials include inorganic compounds, organic compounds, and metals. With regard to organic materials, all of the polymeric materials with non-centrosymmetric structure and large dipole moment group(s) on the main chain or on the side-chain, or on both chains within the molecules, can be used as candidates for the piezoelectric film. Examples of suitable polymers include, for example, but are not limited to, poly(sodium 4-styrenesulfonate) (“PSS”), poly S-119 (poly(vinylamine)backbone azo chromophore), and their derivatives; polyfluorocarbons, including polyvinylidene fluoride (“PVDF”), its co-polymer vinylidene fluoride (“VDF”), trifluoroethylene (TrFE), and their derivatives; polychlorocarbons, including poly(vinyl chloride) (“PVC”), polyvinylidene chloride (“PVDC”), and their derivatives; polyacrylonitriles (“PAN”), and their derivatives; polycarboxylic acids, including poly(methacrylic acid (“PMA”), and their derivatives; polyureas, and their derivatives; polyurethanes (“PU”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including Kapton molecules and polyetherimide (“PEI”), and their derivatives; all of the membrane polymers; poly(N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains, and mixtures thereof.

Further, piezoelectric materials can include Pt, Pd, Ni, Ti, Cr, Fe, Ag, Au, Cu, and metal alloys and mixtures thereof. These piezoelectric materials can also include, for example, metal oxide such as SiO2, Al2O3, ZrO2, TiO2, SrTiO3, PbTiO3, BaTiO3, FeO3, Fe3O4, ZnO, and mixtures thereof, and Group VIA and IIB compounds, such as CdSe, CdS, GaAs, AgCaSe 2, ZnSe, GaP, InP, ZnS, and mixtures thereof. Suitable active materials include, without limitation, shape memory alloys (SMA), ferromagnetic SMAs, shape memory polymers (SMP), piezoelectric materials, electroactive polymers (EAP), magnetorheological fluids and elastomers (MR), and electrorheological fluids (ER).

The activation signal provided by the activation device may include a heat signal, a magnetic signal, an electrical signal, a pneumatic signal, a mechanical signal, and the like, and combinations comprising at least one of the foregoing signals, with the particular activation signal dependent on the materials and/or configuration of the active material. For example, a magnetic and/or an electrical signal may be applied for changing the property of the active material fabricated from magnetostrictive materials. A heat signal may be applied for changing the property of the active material fabricated from shape memory alloys and/or shape memory polymers. An electrical signal may be applied for changing the property of the active material fabricated from electroactive materials, piezoelectrics, electrostatics, and/or ionic polymer metal composite materials.

In some embodiments, the active material 628 may be configured to change in size or shape and thereby exert a force that is transferred to the roll bar, such as by a cam or the like. In other embodiments, the change in attribute of the active material may release a latch or open a valve, etc. to permit a spring or fluid pressure to transmit a force to the member 812. For example, the active material may itself function as a latch due to switchable on-demand stiffness or strength.

In one exemplary embodiment, actuator 66 is of the type described in U.S. patent application Ser. No. 11/533,417, filed Sep. 20, 2006, and which is hereby incorporated by reference in its entirety. In another exemplary embodiment, actuator 66 is of the type described in U.S. patent application Ser. No. 11/533,430, filed Sep. 20, 2006, and which is hereby incorporated by reference in its entirety. In yet another exemplary embodiment, actuator 66 is of the type described in U.S. patent application Ser. No. 11/533,422, filed Sep. 20, 2006, and which is hereby incorporated by reference in its entirety.

While the best modes for carrying out the invention have been described in detail, those familiar with the art to which this invention relates will recognize various alternative designs and embodiments for practicing the invention within the scope of the appended claims.

1. A vehicle comprising:
a vehicle body;
a roll bar mounted with respect to the vehicle body and being selectively movable between a lowered position and an elevated position and/or elevated to lowered; and
an actuator including an active material being configured to undergo a change in at least one attribute in response to an activation signal; said active material being operatively connected to the roll bar such that said change in at least one attribute causes the roll bar to move relative to the vehicle body.

2. The vehicle of claim 1, further comprising a cam being selectively rotatable with respect to the vehicle body and being operatively connected to the roll bar such that rotation of the cam causes the roll bar to move from its lowered position to its elevated position; and
wherein said active material is operatively connected to said cam such that said change in at least one attribute of the active material causes said cam to rotate.

3. The vehicle of claim 1, wherein said roll bar is pivotably mounted with respect to the vehicle body and is selectively pivotable between the lowered and the elevated positions.

4. The vehicle of claim 1, wherein said roll bar is selectively translatable between the lowered and elevated positions.

5. The vehicle of claim 1, wherein the active material is selected from the group consisting of shape memory alloys, shape memory polymers, electroactive polymers, and piezoelectric materials.

6. The vehicle of claim 1, wherein said activation signal is selected from the group consisting of electric signals, magnetic signals, and thermal signals.

7. The vehicle of claim 1, wherein the roll bar includes a first post being pivotably mounted with respect to the vehicle body; a second post being pivotably mounted with respect to the vehicle body; and a selectively collapsible cross member operatively interconnecting the first and second posts.

8. The vehicle of claim 1, wherein said at least one attribute includes size or shape; and wherein said actuator is configured such that the active material exerts a force when changing size or shape that is transmitted to the roll bar.

9. The vehicle of claim 1, wherein said change in at least one attribute opens or closes a valve.

10. The vehicle of claim 1, wherein said change in at least one attribute releases a latch.

11. The vehicle of claim 1, wherein said active material functions as a latch; and wherein said change in at least one attribute includes stiffness or shear strength.

12. A roll bar apparatus for a vehicle comprising:
a roll bar; and
an actuator including an active material being configured to undergo a change in at least one attribute in response to an activation signal; said active material being operatively connected to the roll bar such that said change in at least one attribute causes movement of the roll bar.

13. The roll bar apparatus of claim 12, wherein the active material is selected from the group consisting of shape memory alloys, shape memory polymers, electroactive polymers, and piezoelectric materials.

14. The roll bar apparatus of claim 12, wherein said activation signal is selected from the group consisting of electric signals, magnetic signals, and thermal signals.
